(19) United States
(12) Patent Application Publication
(10) Pub. No.: US 2025/0297882 A1
(43) Pub. Date: Sep. 25, 2025

(54) SMART SENSOR DEVICE FOR CONTAINER SYSTEMS

(71) Applicant: READYBIT INC., Silverdale, WA (US)

(72) Inventors: Trevor William Wilcox, Silverdale, WA (US); Matthew Randall Williams, Vashon, WA (US)

(21) Appl. No.: 19/232,089

(22) Filed: Jun. 9, 2025

Related U.S. Application Data
(63) Continuation-in-part of application No. 18/611,547, filed on Mar. 20, 2024.
(60) Provisional application No. 63/491,326, filed on Mar. 21, 2023.

(51) Int. Cl. G01F 23/284; G01S 7/04; G01S 13/88; G06Q 10/087; G08B 21/18

(52) U.S. Cl. CPC G01F 23/284; G01S 7/04; G01S 13/88; G06Q 10/087; G08B 21/182

(57) ABSTRACT

Systems, methods, and devices relate to a smart sensor usable for monitoring materials within container systems. A smart sensor device may include a base portion provided on an exterior of a tank containing a material, and an internal cavity housing a sensor to detect a level of the material within the tank through an outer surface of the container. The smart sensor device may track readings over time, from one or more container systems, and identify various usage trends. Usage trends and safety alerts may include current supply levels, historical usage rates, and low-level alerts. Such alerts and notifications may be communicated to a dashboard on a remote computing device.

### CROSS REFERENCE TO RELATED APPLICATIONS

This application claims benefit to U.S. patent application Ser. No. 18/611,547, filed Mar. 20, 2024, and Provisional U.S. Patent Application No. 63/491,326, filed Mar. 21, 2023, the contents of which are incorporated herein by reference in their entirety.

### BACKGROUND

Many industrial and commercial operations utilize large tanks, buckets, and varying sizes of containers to store and transport liquids. Large containers, such as a standard 55-gallon drum, are regularly used in various industries, such as culinary, automotive, transportation, and agricultural industries, among others. Many of these containers contain liquids and other elements needed for regular business operations, and monitoring the containers is typically done manually, with at least one worker ensuring that a container is kept filled and ready for operations.

In commercial kitchens, for example, large commercial drums may be filled with detergent for kitchen operations. The detergent supply within the tank may be connected to a pump system connected to a dishwasher machine. The detergent tank must be manually monitored and refilled when the tanks run low in order to keep operations running smoothly. However, such manual operations are inefficient and require at least one worker's dedicated attention to the tank system.

In other examples, such tanks and container systems may carry hazardous chemicals or other materials. The containers may also be connected to a pump system, which can deliver the liquids to or from the container. In some cases, manual monitoring may pose a risk, such as a biohazard risk to workers, or be unavailable, and unmonitored and unserviced systems may pose additional safety risks, such as fire risks, pump system failures, and leakages.

Since some businesses and environments utilize a significant number of container systems (e.g., tens or hundreds of tanks, etc.), the manual monitoring requirements of the tank systems can increase significantly. Accordingly, improvements are needed to efficiently monitor contents of container systems in a safe and effective manner.

### SUMMARY

In meeting the described challenges, the present disclosure relates to a smart cap device (also referred to herein as a smart sensor device) and related systems and methods for operating the smart cap and monitoring contents of an associated container system. In various examples, a smart cap device may include a base portion configured to an exterior of a tank containing a material, an internal cavity housing a sensor system to detect a level of the material within the tank, and a removable lid providing access to the internal cavity. The sensor system may detect the level of the material through an outer surface of the container. In examples, the smart cap device may further include a processor and at least one memory to generate an alert based on the level of the material.

In examples, the smart cap device can include a base portion attached to an exterior of a container having known dimensions containing a material, an internal cavity housing a sensor to detect a level of the material within the container, and a processor and at least one memory configured to generate an alert based on the level of the material. As discussed herein, the sensor can detect the level of the material through an outer surface of the container.

The sensor system may detect the level of the material using at least one of pulsed coherent radar, ultrasonic sensors, and laser time of flight. In examples, the level of the material may be detected using a 60 GHz pulsed coherent radar. Additional sensors may include a laser sensor, a distance sensor, photosensor, a temperature sensor, a location sensor, and a cellular connection. The internal cavity may further include a battery cavity to store a battery to power the sensor system. The smart cap device may also include a charging port to charge the battery and/or receive power for the sensor system. The smart cap device may also include an inertial measurement unit to detect at least one of a shock, a vibration, and a movement experienced by the container. A display associated with the smart cap device may provide at least one of a current sensor reading, analytics derived from the detected level of material, and device information. The display may include at least one of a liquid crystal display and a backlight. The smart cap device may include a button, such as a multi-function button, to perform operational actions comprising at least one of initiating the sensor to detect the level of the material and operating the display.

Aspects of the present disclosure further include methods for monitoring a container system. Such methods include detecting, via a sensor, such as a laser sensor, a first level of a material within the container system at a first time, wherein the sensor is provided within a smart cap device secured to an opening of the container system, and providing information indicative of the first level of the material to a remote computing device. Additionally, systems and methods may further include detecting, via the sensor, a second level of the material at a second time, determining a usage trend for the material based on the first level and the second level, and providing a notification comprising the usage trend to the remote computing device. Usage trends may include at least one of a rate of depletion, a current level of the material, or an estimated depletion time. A safety hazard may also be detected and communicated to the remote computing device.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings, exemplary embodiments of the disclosed subject matter; however, the disclosed subject matter is not limited to the specific methods, compositions, and devices disclosed. In addition, the drawings are not necessarily drawn to scale. In the drawings:

FIG. 1A illustrates a transparent side view of a smart cap, in accordance with various aspects discussed herein.

FIG. 1B illustrates another transparent side view of a smart cap, in accordance with various aspects discussed herein.

FIG. 1C illustrates a perspective view of a smart cap, in accordance with various aspects discussed herein.

FIG. 1D illustrates another side view, including a battery enclosure, in accordance with various aspects discussed herein.

FIG. 2A illustrates a transparent top view of a smart cap, in accordance with various aspects discussed herein.

FIG. 2B illustrates a transparent bottom view of smart cap, in accordance with various aspects discussed herein.

FIG. 3A illustrates a cross-sectional side view of a smart cap, in accordance with various aspects discussed herein.

FIG. 3B illustrates another cross-sectional side view of a smart cap, in accordance with various aspects discussed herein.

FIG. 4 illustrates a bottom, perspective view, in accordance with various aspects discussed herein.

FIG. 5A illustrates a side view of a smart cap including a charging port, in accordance with various aspects discussed herein.

FIG. 5B illustrates a top perspective view of a smart cap with internal communication hardware, in accordance with various aspects discussed herein.

FIG. 5C illustrates another top perspective view of a smart cap and a sensor board, in accordance with various aspects discussed herein.

FIG. 6 illustrates an example system architecture, in accordance with aspects discussed herein.

FIG. 7 illustrates an example local network bridge architecture, in accordance with aspects discussed herein.

FIG. 8 illustrates an example control network bridge architecture, in accordance with aspects discussed herein.

FIG. 9 illustrates a device mesh bridge architecture, in accordance with aspects discussed herein.

FIG. 10 illustrates a backend initialization flowchart, in accordance with aspects discussed herein.

FIG. 11 illustrates a communication protocol, in accordance with aspects discussed herein.

FIG. 12 illustrates a synchronization protocol, in accordance with aspects discussed herein.

FIG. 13 illustrates a block diagram of an example device in accordance, with various aspects discussed herein.

FIG. 14 illustrates a block diagram of an example computing system, in accordance with various aspects discussed herein.

FIG. 15 illustrates a machine learning and training model, in accordance with various aspects discussed herein.

FIG. 16 illustrates a computing system, in accordance with various aspects discussed herein.

FIG. 17A illustrates an exploded view of a smart sensor device, in accordance with aspects discussed herein.

FIG. 17B illustrates an additional view of the smart sensor device of FIG. 17A, in accordance with aspects discussed herein.

FIG. 18 illustrates an additional example of a smart sensor device.

FIG. 19 illustrates additional components of the smart sensor device of FIG. 18, in accordance with aspects discussed herein.

FIG. 20 illustrates an example firmware flow, in accordance with aspects discussed herein.

The figures depict various examples for purposes of illustration only. One skilled in the art will readily recognize from the following discussion that alternative examples of the structures and methods illustrated herein may be employed without departing from the principles described herein.

### DETAILED DESCRIPTION OF ILLUSTRATIVE EMBODIMENTS

The present disclosure can be understood more readily by reference to the following detailed description taken in connection with the accompanying figures and examples, which form a part of this disclosure. It is to be understood that this disclosure is not limited to the specific devices, methods, applications, conditions, or parameters described and/or shown herein, and that the terminology used herein is for the purpose of describing particular embodiments by way of example only and is not intended to be limiting of the claimed subject matter.

Some examples of the present invention will now be described more fully hereinafter with reference to the accompanying drawings, in which some, but not all examples of the invention are shown. Indeed, various examples of the invention may be embodied in many different forms and should not be construed as limited to the examples set forth herein. Like reference numerals refer to like elements throughout. As used herein, the terms “data,” “content,” “information,” and similar terms may be used interchangeably to refer to data capable of being transmitted, received, and/or stored in accordance with examples of the invention. Moreover, the term “exemplary,” as used herein, is not provided to convey any qualitative assessment, but instead merely to convey an illustration of an example. Thus, use of any such terms should not be taken to limit the spirit and scope of examples of the invention.

As defined herein, a “computer-readable storage medium,” which refers to a non-transitory, physical, or tangible storage medium (e.g., volatile or non-volatile memory device), may be differentiated from a “computer-readable transmission medium,” which refers to an electromagnetic signal.

References in this description to “an example,” “one example,” or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,” “an,” and “the” include the plural, and reference to a particular numerical value includes at least that particular value, unless the context clearly dictates otherwise. The term “plurality,” as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, can also be provided in combination in a single embodiment. Conversely, various features of the disclosed subject matter that are, for brevity, described in the context of a single embodiment, can also be provided separately or in any sub-combination. Further, any reference to values stated in ranges includes each and every value within that range. Any documents cited herein are incorporated herein by reference in their entireties for any and all purposes.

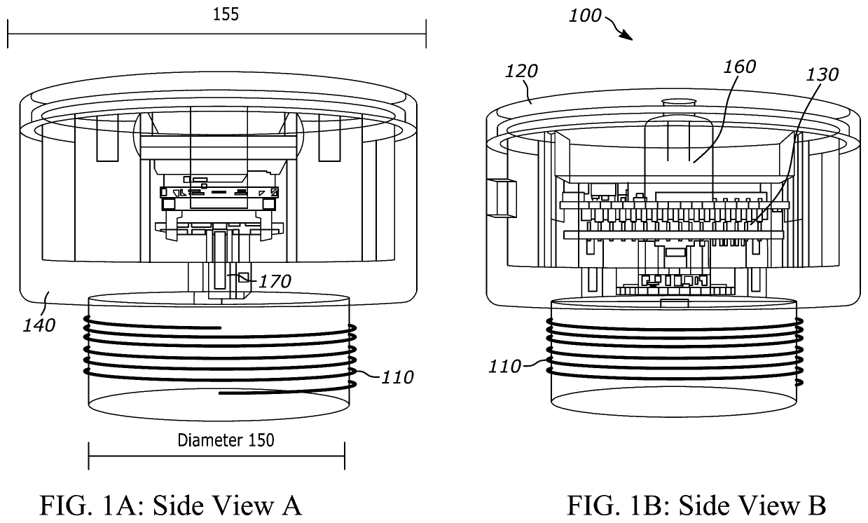

In various aspects, systems, methods, and devices discussed herein relate to a smart cap device, usable for monitoring container systems and related operations. FIG. 1A illustrates a side view of a smart cap device 100, and FIG. 1B illustrates an alternate side view of the smart cap device 100 rotated by 90° along a vertical, central axis. The smart cap 100 may be installed on an opening of a container system, which can include, for example, a tank, container, drum, or the like. The container may be any size container having known dimensions, such as a standard 55-gallon (208 liter) drum. In various examples, the 55-gallon drum can be a standard size, having a 22.5″ internal diameter, 33.5″ internal height, a 23″ outer diameter, and a 35.25″ outer height. The smart cap 100 may be applicable with any variety of containers, barrels, and drums, including but not limited to open head or tight head drums and steel, carbon steel, stainless steel, and plastic drums.

In some examples, the smart cap 100 fits on an opening, e.g., in place of a bung, of a 55-gallon container. The opening may be a standard size, and threads 110 on a base portion of the smart cap 100 may be sized with a diameter 150 to fit within the container opening. The diameter 150 of the threaded portion may, for example, be approximately 2″. Threads 110 may also be sized accordingly to the opening to which it will be fitted. The base portion may create a seal when fitted into an opening of a container and prevent leaking or other extraction of the liquid or material within the container.

The top of the smart cap device may have a larger diameter 155 than the base diameter 150. For example, the top diameter 155 may be approximately 4″. Again, the smart cap may be sized based on the container to which it will be fitted. As such, diameters 150, 155 may be the same, or one may be smaller or greater than the other, depending on the particular application for the smart cap device.

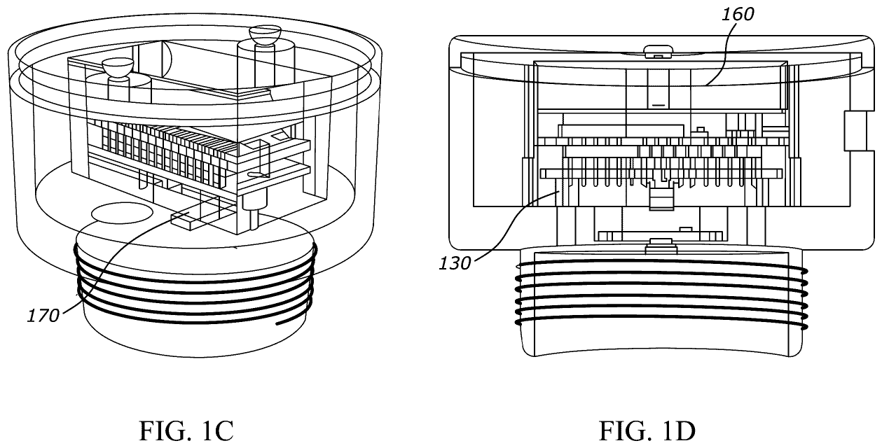

FIGS. 1C and 1D illustrate an additional view of the smart cap device 100 and positioning of the internal sensors 130. In some examples, sensors 130 may be secured to an internal structure, which may be positioned between posts 210 (as shown in FIG. 2A). The sensors may be particularly positioned, such as a time of flight sensor 170, as discussed below.

In various embodiments, a top portion of the smart cap may include a lid 120, which may be a removable lid 120. FIG. 2A illustrates a top view of the smart cap device 100, including the removable lid 120. The lid 120 may provide access to a battery cavity 160 and internal sensor components 130, such as sensors, chips, printed circuit boards, interconnect boards, cellular-connected boards, and other electronic features as discussed herein. A pair of posts 210 may provide stability for the battery cavity 160 and/or internal sensor components 130. In some embodiments, the posts 210 may provide an attachment point for the lid 120. However, it should be noted that the lid may attach in any of a plurality of ways, including but not limited to, friction, threads that correspond to the base portion of the smart cap, a snap-fit design, or other designs.

As seen in FIG. 2B, which provides a transparent bottom view, the smart cap device 100 includes one or more sensors, such as time of flight sensor 170, to measure the level of components, such as liquids and/or other materials, held within the container. The one or more sensors may be configured to communicate with an external device to provide readings and other measurements, which may be done in real time, on a scheduled basis, on demand, or any of a combination of such methods.

According to various examples, the internal sensor components 130 may measure, for example, a level of liquid (or other material) within the container, a temperature, a humidity level, a pressure, or other monitorable feature. In various examples, the sensor may utilize, e.g., time of flight sensor 170, to determine a level of the liquid (or other material) within the container. The time of flight sensor may pulse a laser to send infrared light through an opening 220 in the bottom portion of the smart cap 100, and measure the time difference between the light's emission and its reflection after contacting the liquid or other material within the container. As the liquid is used within the container, for example, the time of flight sensors will record a greater time lapse between laser emission and receipt of the reflected light. Various laser time of flight methods may be applied, in accordance with embodiments. For example, laser time of flight measurements may be directly measured, using timed pulses. In other examples, phase shifts of modulated waves may be measured and utilized to determine a distance to the contained material, and therefore the level of the material remaining within the container. In additional examples, ultrasonic waves may be utilized for one or more sensor measurements.

In some examples, the internal sensor components 130 may track readings over a period of time (e.g., every few minutes, once an hour, every few hours, once a day, etc.), and may identify trends and/or make predictions regarding the use of the material within the container. For example, a sensor may take several liquid level measurements using a laser time of flight method. Based on the time that the liquid level measurements were taken, a rate of depletion may be calculated. The rate of depletion may provide an estimate for when the container will be empty.

Other predictive capabilities may include safety predictions. The one or more sensors may detect a measurement indicative of an unsafe condition. For example, a barometric sensor may indicate an unsafe pressure measurement within the container. A temperature sensor or thermistor may identify temperature fluctuations or when a temperature within the container is outside of a known safe temperature range. Photosensors may provide light information, which may be particularly useful if the material within the container is photosensitive (e.g., wine, milk, consumable liquids, etc.). A pH sensor may provide pH indications and readings over time.

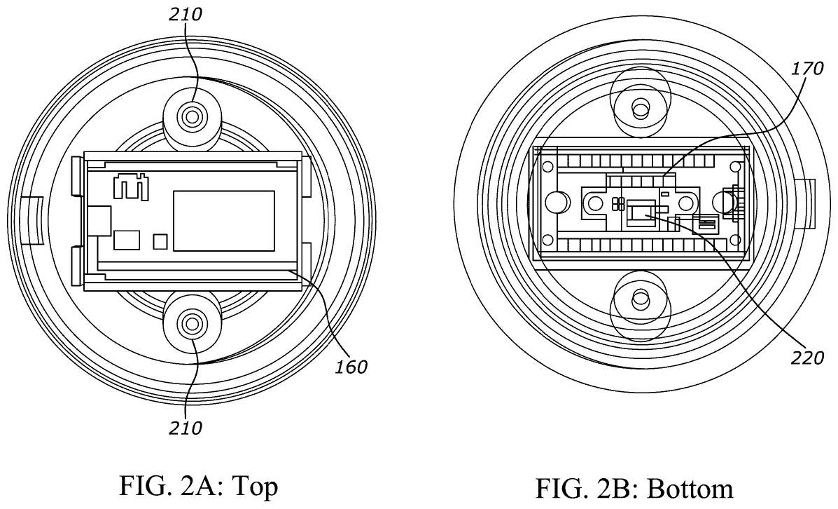

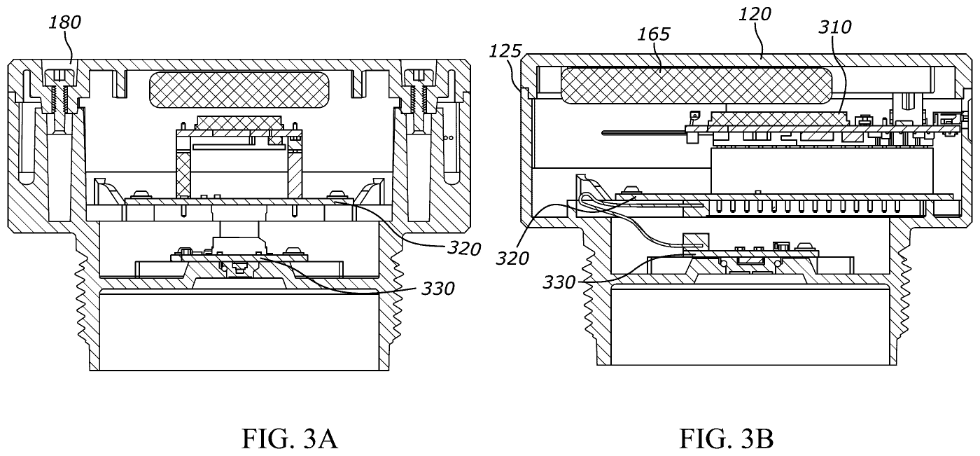

FIGS. 3A, 3B, and 4 provide additional cross-sectional side views of an example smart cap device. FIG. 3B illustrates a side view of the smart cap device of FIG. 1A, rotated by 90° along a vertical, central axis. FIG. 4 illustrates a bottom perspective view of the smart cap device and internal electric components.

As discussed herein, the smart cap device may include a lid 120. The lid may be held in place and secured to a lower section 125 via one or more attachment mechanisms 180, such as two screws on opposite sides of the lid 120. The attachment mechanisms may help ensure a seal to keep out elements such as water, dust, and other particles.

The battery 165 may be provided at a top section of the internal device cavity to provide easy access and replacement when the lid 120 is removed. Below the battery, one or more layers of circuit boards, e.g., boards 310, 320, 330, may provide various communication, sensing, and processing functionalities. For example, a first circuit board 310 may provide an antenna and/or other communication hardware and functionalities. A second circuit board 320 may provide further communication (e.g., LTE) and/or processing capabilities. A third circuit board 320 may be an interconnect board and assist with sensor and/or signal processing. More or fewer circuit boards may be utilized, depending on the smart cap device application. Any combination of electronics, circuit boards, and internal ordering and positioning may be provided within the smart cap to provide the various electronic, sensing, and communication functionalities discussed herein.

In an example, one or more boards 310, 320, 330 may include and/or connect one or more sensors, such as the internal sensor components 130 discussed herein, a time of flight sensor 170, a laser sensor, and other sensors, as desired.

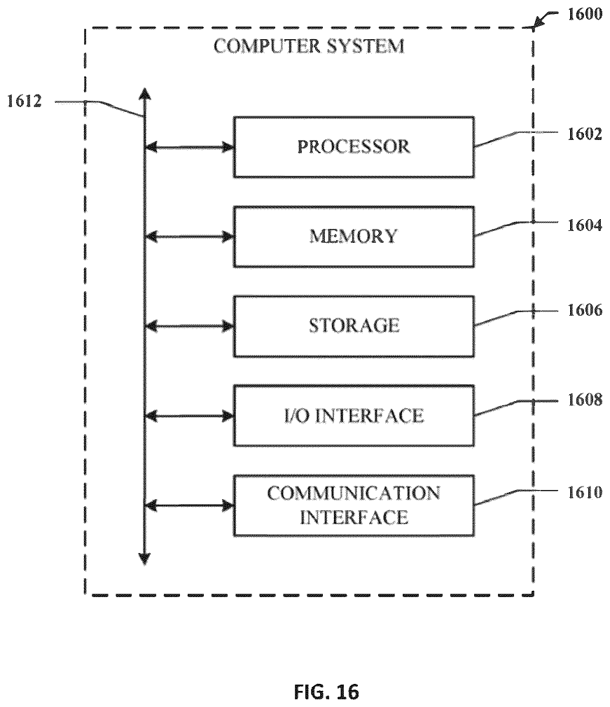

An interconnect board may process and facilitate connections and communications between internal electrical components. The interconnect board may establish electrical connections, perform signal routing and data transfer, and provide measurement and sensing capabilities. As such, the interconnect board may include a processor and other computer system elements, as discussed herein and illustrated, for example, in FIG. 16.

One or more boards 310, 320, 330 may further include a communications board to send and receive cellular communications. In an example, internal circuitry may include LTE-enabled features to support communications between the smart cap and an external communications device.

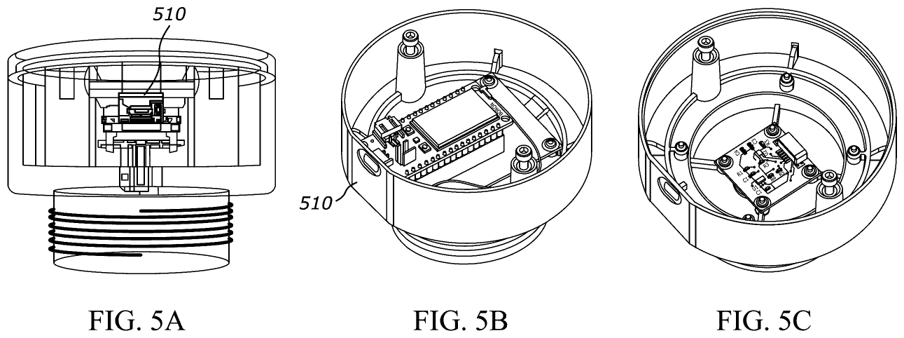

As discussed herein, the smart cap device 100 may provide communications or other notifications regarding current conditions within the container, trends regarding one or more conditions, a liquid level within the container, and the like. In some embodiments, the smart cap device may communicate with an external device, such as a computing device, to provide such readings, measurement, and predictive estimates. (See, e.g., FIGS. 6-12). In some examples, the smart cap device 100 may provide readings and other information via a communication network to one or more computing devices, which may process the data. The processed data may be communicated to a user device.

A dashboard on the user device may provide information regarding the container and the one or more sensors measurements and predictions, as discussed herein. The dashboard may be displayed on a graphical user interface associated with a user device. In some cases, the dashboard may be accessible via a downloadable app on the user device, such as a cell phone, tablet, laptop, or other mobile computing device. The dashboard may provide a current supply level, a historical supply level (e.g., over several hours, days, months, etc.), informative information from the sensors within the smart cap, or other information of interest, such as a daily supply usage.

In additional examples, alerts may be pushed to the user device, e.g., via the dashboard, the app, over text message, email, phone notification, etc. The alerts may relate to smart cap readings; provide a low level alert, a low battery alert, or an indication that a refill is needed or will be needed soon; and/or provide a safety alert. In some examples, the alert may be generated via a light source, such as an LED. The light source may be provided on, in, and/or around the smart cap device. An illuminated light source may indicate any of the alerts discussed above. Various lighting schemes, flashes, sequences, colors, and the like may communicate different reading information and usage trends.

In some examples, multiple smart caps devices may be monitored via one dashboard. For example, in a warehouse containing hundreds of containers, if a smart cap device is installed on each container, the plurality of containers may be monitored. Data from each of the smart cap devices may be provided on the dashboard, thus enabling a single individual to monitor the plurality of containers continuously and simultaneously, without performing time-consuming, manual checks on each device. In addition, if a safety issue or other malfunction were to occur, the smart cap device could recognize and report the hazard or malfunction in real time or as soon as an abnormal reading was obtained. Since many hazards and failures (e.g., pump failures, leakages, etc.) may happen without notice, the smart cap device may identify issues quicker than during routine monitoring and manual maintenance and notify the appropriate person(s) immediately.

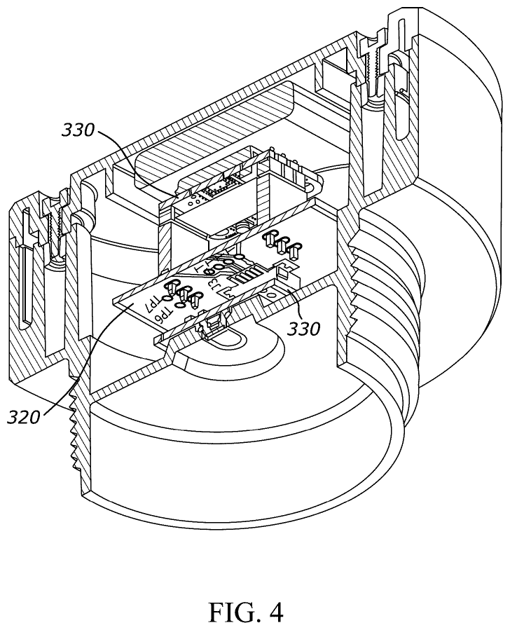

FIG. 5A illustrates a transparent side view of a smart cap device including a charging port 510. In some examples, a battery within the smart cap device may be rechargeable, and a charging port may receive any of a plurality of connectors, such a USB-A, USB-B, USB-B Mini, USB-B Micro, USB-C, or Lightning. In some cases, the smart cap device may remain plugged into power during use and operation. In other examples, the smart cap device may be charged and can operate on battery power for a period of time. As discussed above, the internal sensor components may include a battery power sensor and send a notification to the dashboard when the smart cap device is running out of power and needs a battery charge or battery replacement.

FIG. 5B illustrates a top perspective view of the smart cap device with the lid and battery (e.g., lid 120 and battery 165) removed. A top layer may include one or more circuit boards including communications-enabled features, an antenna, an interconnect, and a battery source (e.g., battery 165, not shown). A lower layer, as seen in FIG. 5C, may include one or more additional circuit boards, which may include one or more sensors and interconnects. FIG. 5C further illustrates a top perspective view of an example internal cavity of a smart cap, which may be modified and reshaped, as desired, based on a particular smart cap application and/or desired sensing and communication capabilities of the smart cap.

FIG. 6 illustrates an example system architecture usable with the smart cap device, as discussed herein. The sensor device 610 may be installed on an application target, such as a container system, drum, tank, and the like. Any of a plurality of sensors and sensor types may gather information regarding the components of the application target. For example, a level sensor, thermistor, and/or pH sensor may be applied, as well as others, as discussed herein. A battery associated with the sensor device may provide power to a power management integrated circuit (PMIC) and a fuel gauge. The fuel gauge may further provide data to the PMIC. The PMIC communicates with a network radio and a microcontroller unit (MCU), which receives sensor information. The network radio communicates with cellular network 640.

A web application 620 communicates with both cellular network 640 and public internet 630. Public internet 630 may provide data from the web application to the user to send encrypted, secure information to a user, e.g., via HTTPS, accessible over a web browser. As such, data from the sensor device 610 is exchanged with the web application 620 via the cellular network 640, and information may be exchanged between the web application 620 and the user 630 via public internet 650.

As illustrated in FIG. 6, the web application 620 may include a device gateway in communication with the cellular network. The device gateway interacts and exchanges communication with a data aggregator, connected to a device database, and a business application. A device management module may receive information from the business application and provide additional data communications to the device gateway and data aggregator. The business application feeds the user dashboards, which are accessible and communicated to the user via the internet 650. It should be appreciated that the system architecture of FIG. 6 is but one example for implementing various systems, methods, and aspects discussed herein and are non-limiting.

In addition, the device gateway may bridge together smart caps and wired communications via Bluetooth Low Energy (BLE). In various examples, this arrangement could apply to environments where typical smart cap wireless networks (for example, LTE Cat M1) are unavailable. According to various aspects and embodiments, the device gateway would interface with some combination of Ethernet, Wi-Fi, 4-20, and Modbus. Such interfaces would allow the smart caps to connect to public internet, similar to various examples discussed herein, and/or to use industrial communication interfaces to integrate with building monitoring systems.

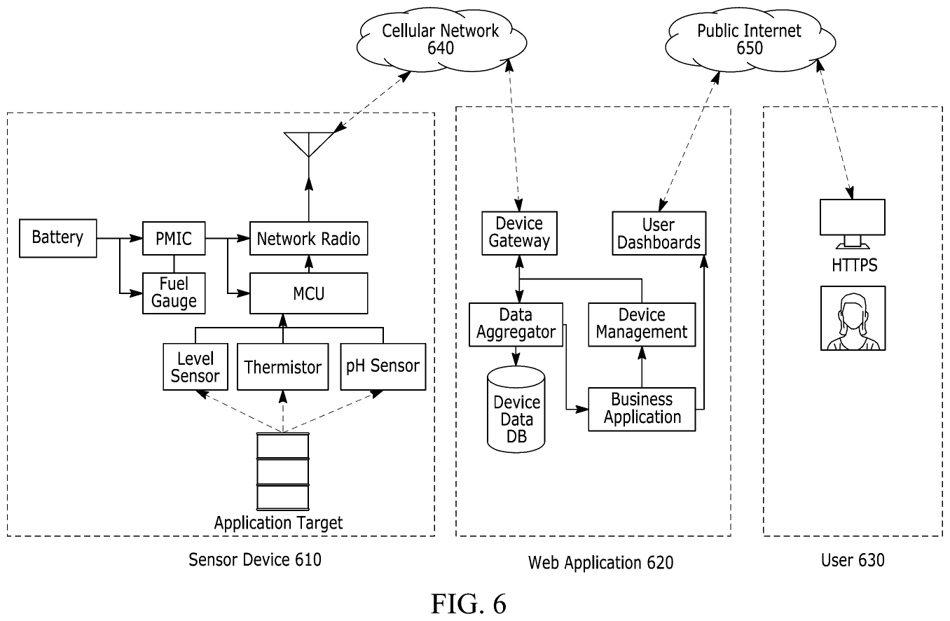

FIG. 7 illustrates an example local network bridge architecture 700. In various examples, a gateway device can connect a smart cap to a local network if a direct connection to the cellular network is not available at the smart cap (e.g., when there is a low signal). As illustrated in FIG. 7, the connection to cellular network 640 is unavailable, so communication occurs with the gateway device. The device gateway may then access the public internet 650 via a wireless access point and/or an ethernet router. From there, the public internet 650 can communicate and exchange information with the web application and/or the user. As discussed herein, the web application may be accessed on a user device, such as a smart phone, or other computing system.

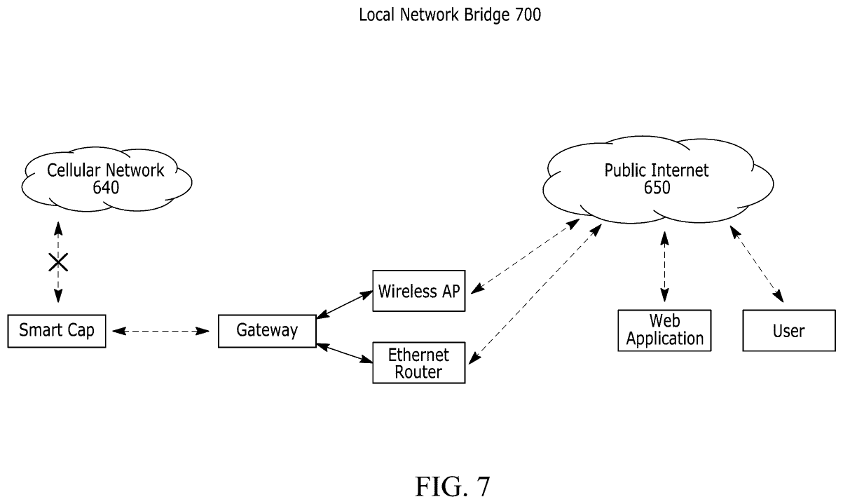

FIG. 8 illustrates an example control network bridge architecture 800. In various control network bridge examples, the smart cap device can communicate with the cellular network 640 and the gateway device. The gateway device can provide a standard interface (e.g., Modbus, 4-20 mA) for connecting to the public internet 650 and industrial control network(s) 810. Industrial control networks can include, for example, building management systems. Similar to other examples discussed herein, the public internet can then communicate with a web application and/or the user.

In various examples, the web application may send data to the industrial control network, and the gateway device may transmit data directly to the industrial control network. The industrial control network may further communicate with industrial control software, which can provide further communication to the user and/or other industrial processes.

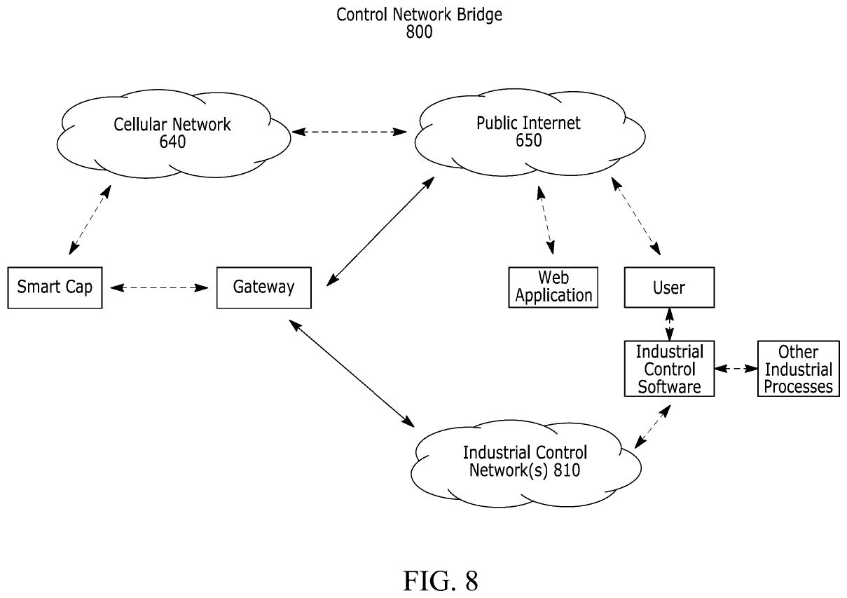

FIG. 9 illustrates a device mesh bridge architecture 900. In various examples, smart caps can use other smart caps to form a mesh network for relaying sensor data if a direct connection to a cellular network is not available at the smart cap. As illustrated in FIG. 9, smart cap 910 cannot communicate with cellular network 640. When this occurs, the smart cap 910 can look for other smart caps to communicate with, such as smart caps 920, 930. The other smart caps may or may not be in communication with each other. In the present example, smart caps 920, 930 do not communicate with each other.

Smart cap 920 is in communication with cellular network 640. In the device mesh bridge architecture, smart cap 910 can therefore communicate with cellular network 640 via smart cap 920. Similar to other examples, the cellular network 640 can then communicate with public internet 650, which can communicate with a web application and/or the user.

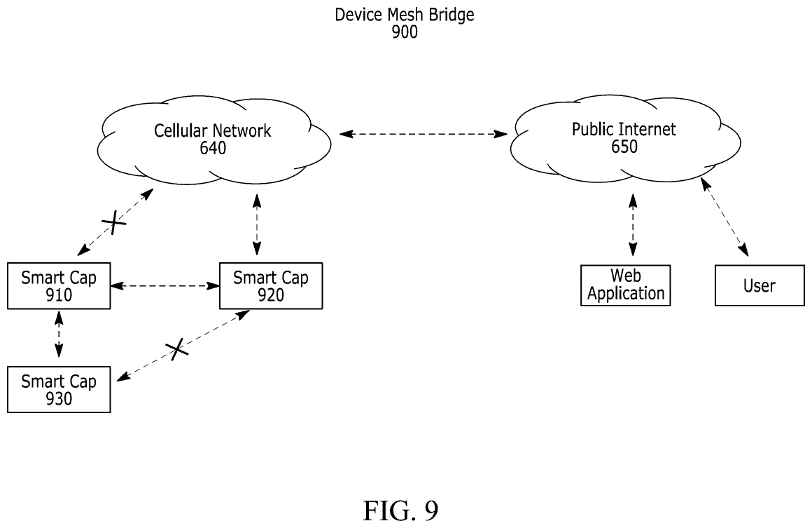

FIG. 10 illustrates an example backend initialization flowchart, in accordance with aspects discussed herein. Such operations may be implemented to initialize aspects of the associated software application for managing and operating the smart cap device. Backend initialization 1000 establishes connections to one or more databases associated with the smart cap device.

During initialization, the backend may load various configuration settings, establish various security parameters, manage connections, and facilitate operations between system services, such as Storage Service 1010, User Service 1020, Customer Service 1030, and Stream Service 1040. Various services may connect to and/or utilize subsequent clients and client services.

The Storage Service 1010 may further utilize one or more database clients, such as a MySQL database client and a TimeSeries database client. A MySQL client may enable interactions with a MySQL database server, including but not limited to querying data, managing database schema, and monitoring performance, connectivity, administration, maintenance, automation, and other functionalities. A TimeSeries database client may facilitate interactions and communications with one or more time series databases. Time series databases may further assist with facilitating and managing, for example, the smart cap device and Internet of Things (IoT) devices.

The UserService 1020, CustomerService 1030, and StreamService 1040 layers may each access a StorageService. The StorageService may be a layer providing data management and storage features. The layer may, for example, assist with data storage, retrieval, security, backup, updates, or compression and other data monitoring and management features.

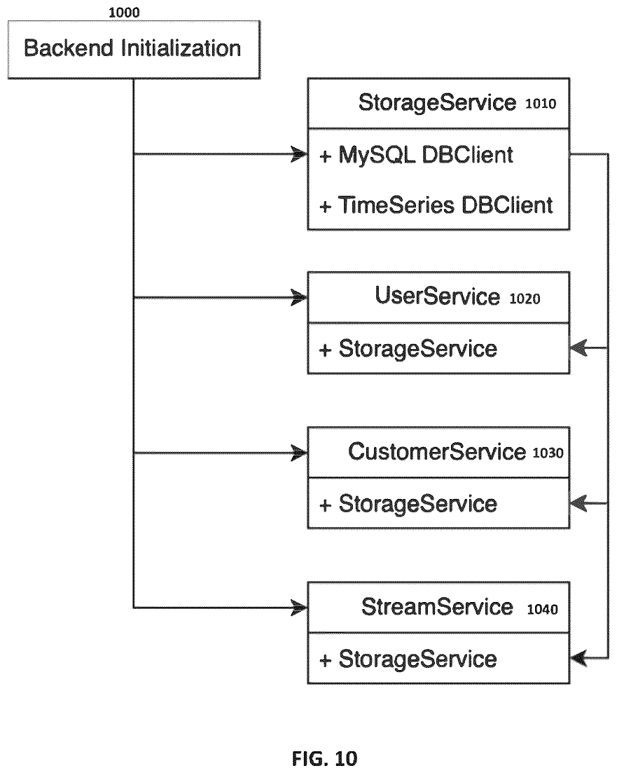

FIG. 11 illustrates an example communications protocol between an application frontend 1110, backend 1120, and database 1130 (e.g., a MySQL Database). A GetUser function 1140 may retrieve information (e.g., user information, device information, etc.) from the frontend 1110 and communicate to the backend 1120. At the backend, various operations, including but not limited to authentication and authorization actions may be performed. For example, the backend 1120 may check bearer token and check user permission.

A ReadUser function 1150 may also retrieve and access information about a particular user. Such information may include, for example, a username, password, device information, device name, and other relevant information. The database 1130 may be queried for some or all of the ReadUser requests and provide such information via a ReturnUser function 1150. The Return User function may pass through the backend 1120, where a conversion to Network model may occur. In such a conversion, data may be transformed from a first data model or data structure to a network data model. The data may then be returned to the frontend 1110 where it may be utilized, as desired or necessary.

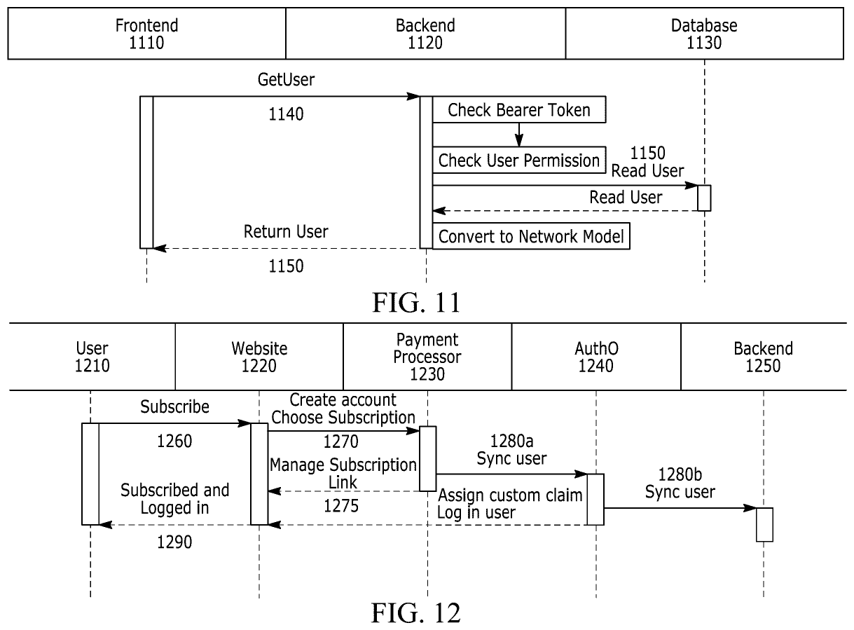

FIG. 12 illustrates an example synchronization protocol usable with various systems and devices discussed herein. A user 1210 may initiate a subscription request 1260, which may be provided to a website 1220. The site may, at step 1270, initialize an account and choose a subscription. In some examples, multiple subscription options may be provided and may have various payments, plans, and options. A payment processor 1230 manages any necessary payment operations and may provide a subscription link 1275 back to website 1220.

A Sync User operation 1280a, 1280b, may pass through an authorization layer 1240 (AuthO), and to the backend 1250. The authorization layer 1240 may assign custom claims and log in the user at website 1220. Website 1220 may then provide a notification or other communication to the user regarding the subscription and log in 1290.

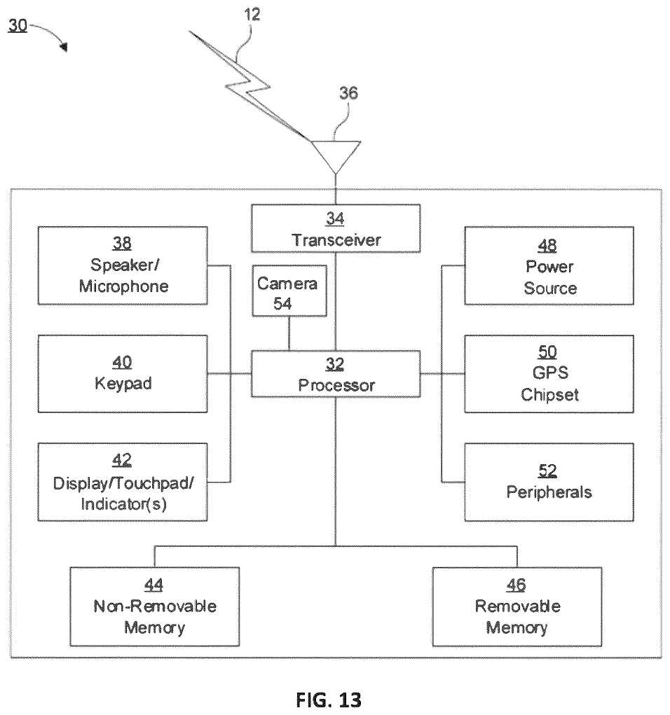

FIG. 13 illustrates a block diagram of an exemplary hardware/software architecture of a UE 30. As shown in FIG. 13, the UE 30 (also referred to herein as node 30) can include a processor 32; non-removable memory 44; removable memory 46; a speaker/microphone 38; a keypad 40; a display, touchpad, and/or indicators 42; a power source 48; a global positioning system (GPS) chipset 50; and other peripherals 52. The UE 30 can also include a camera 54. In an exemplary embodiment, the camera 54 is a smart camera configured to sense images appearing within one or more bounding boxes. The UE 30 can also include communication circuitry, such as a transceiver 34 and a transmit/receive element 36. It will be appreciated the UE 30 can include any sub-combination of the foregoing elements while remaining consistent with an embodiment.

The processor 32 can be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 can execute computer-executable instructions stored in the memory (e.g., non-removable memory 44 and/or memory 46) of the node 30 in order to perform the various required functions of the node. For example, the processor 32 can perform signal coding, data processing, power control, input/output processing, and/or any other functionality that enables the node 30 to operate in a wireless or wired environment. The processor 32 can run application-layer programs (e.g., browsers) and/or radio access-layer (RAN) programs and/or other communications programs. The processor 32 can also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, can control the communication circuitry in order to cause the node 30 to communicate with other nodes via the network to which it is connected.

The transmit/receive element 36 can be configured to transmit signals to, or receive signals from, other nodes or networking equipment. For example, in an embodiment, the transmit/receive element 36 can be an antenna configured to transmit and/or receive radio frequency (RF) signals. The transmit/receive element 36 can support various networks and air interfaces, such as wireless local area network (WLAN), wireless personal area network (WPAN), cellular, and the like. In yet another embodiment, the transmit/receive element 36 can be configured to transmit and receive both RF and light signals. It will be appreciated that the transmit/receive element 36 can be configured to transmit and/or receive any combination of wireless or wired signals.

The transceiver 34 can be configured to modulate the signals that are to be transmitted by the transmit/receive element 36 and to demodulate the signals that are received by the transmit/receive element 36. As noted above, the node 30 can have multi-mode capabilities. Thus, the transceiver 34 can include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 can access information from, and store data in, any type of suitable memory, such as the non-removable memory 44 and/or the removable memory 46. For example, the processor 32 can store session context in its memory, as described above. The non-removable memory 44 can include RAM, ROM, a hard disk, or any other type of memory storage device. The removable memory 46 can include a subscriber identity module (SIM) card, a memory stick, a secure digital (SD) memory card, and the like. In other embodiments, the processor 32 can access information from, and store data in, memory that is not physically located on the node 30, such as on a server or a home computer.

The processor 32 can receive power from the power source 48 and can be configured to distribute and/or control the power to the other components in the node 30. The power source 48 can be any suitable device for powering the node 30. For example, the power source 48 can include one or more dry cell batteries (e.g., nickel-cadmium (NiCad), nickel-zinc (NiZn), nickel metal hydride (NiMH), lithium-ion (Li-ion), etc.), solar cells, fuel cells, and the like.

The processor 32 can also be coupled to the GPS chipset 50, which can be configured to provide location information (e.g., longitude and latitude) regarding the current location of the node 30. It will be appreciated that the node 30 can acquire location information by way of any suitable location-determination method while remaining consistent with an exemplary embodiment.

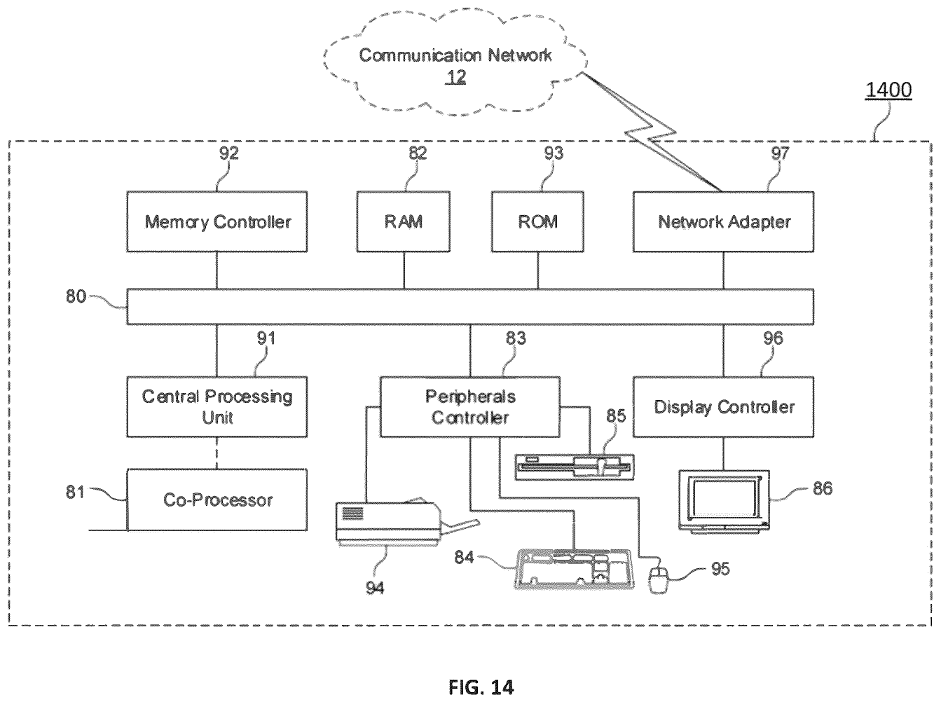

FIG. 14 is a block diagram of a computing system 1400 which can also be used to implement components of the system or be part of the UE 30. The computing system 1400 can comprise a computer or server and can be controlled primarily by computer readable instructions, which can be in the form of software, wherever, or by whatever means, such software is stored or accessed. Such computer readable instructions can be executed within a processor, such as central processing unit (CPU) 91, to cause computing system 1400 to operate. In many workstations, servers, and personal computers, central processing unit 91 can be implemented by a single-chip CPU called a microprocessor. In other machines, the central processing unit 91 can comprise multiple processors. Coprocessor 81 can be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 1400 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories can include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 can be controlled by memory controller 92. Memory controller 92 can provide an address translation function that translates virtual addresses into physical addresses as instructions are executed. Memory controller 92 can also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 1400 can contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 800. Such visual output can include text, graphics, animated graphics, and video. Display 86 can be implemented with a cathode-ray tube (CRT)-based video display, a liquid-crystal display (LCD)-based flat-panel display, gas plasma-based flat-panel display, or a touch panel. Display controller 96 includes electronic components required to generate a video signal that is sent to display 86.

Further, computing system 1400 can contain communication circuitry, such as a network adaptor 97, that can be used to connect computing system 1400 to an external communications network, such as network 12 of FIG. 16, to enable the computing system 800 to communicate with other nodes (e.g., UE 30) of the network.

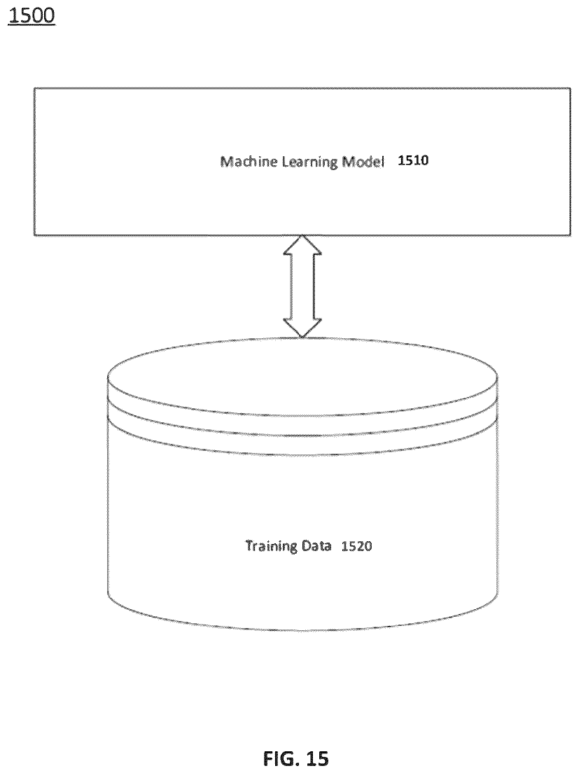

FIG. 15 illustrates a framework 1500 employed by a software application (e.g., algorithm) for evaluating attributes of a gesture. The framework 1500 can be hosted remotely. Alternatively, the framework 1500 can reside within the UE 30 shown in FIG. 13 and/or be processed by the computing system 1400 shown in FIG. 14. The machine learning model 1510 is operably coupled to the stored training data 1520 in a database.

In an exemplary embodiment, the training data 1520 can include attributes of thousands of objects. For example, the object may be identified and/or associated with readings of the smart cap device, such as sensor readings, historical trends, predictive trends, when to order refills, use examples, and the like. Attributes can include but are not limited to particular measurements, such as temperature, pressure, internal liquid/material levels, usage trends, refill shipping times, safety benchmarks associated with such measurements, and the like. The training data 1520 employed by the machine learning model 1510 can be fixed or updated periodically. Alternatively, the training data 1520 can be updated in real time based upon the evaluations performed by the machine learning model 1510 in a non-training mode. This is illustrated by the double-sided arrow connecting the machine learning model 1510 and stored training data 1520.

In operation, the machine learning model 1510 can evaluate attributes of sensor readings obtained by hardware (e.g., the smart cap device 100, etc.). For example, the smart cap device may track historical data, such as a rate of depletion, temperature or pressure fluctuations, how often the container is or has been refilled, and the like. The collected attributes from the smart cap device are then compared with respective attributes of stored training data 1520. The likelihood of similarity between each of the obtained attributes (e.g., material/liquid, etc.) and the stored training data 1520 (e.g., associated depletion rates or timing related to how long a refill takes to order, arrive, be installed, etc.) is given a confidence score. In one exemplary embodiment, if the confidence score exceeds a predetermined threshold, the attribute is included in the dashboard or other alert/notification that is ultimately communicated to the user via a user interface of a computing device (e.g., UE 30, computing device). In another exemplary embodiment, the description can include a certain number of attributes which exceed a predetermined threshold to share with the user. The sensitivity of sharing more or fewer attributes can be customized based upon the needs of the particular user.

FIG. 16 illustrates an example computer system 1600. In exemplary embodiments, one or more computer systems 1600 perform one or more steps of one or more methods described or illustrated herein. In particular embodiments, one or more computer systems 1600 provide functionality described or illustrated herein. In exemplary embodiments, software running on one or more computer systems 1600 performs one or more steps of one or more methods described or illustrated herein, or provides functionality described or illustrated herein. Exemplary embodiments include one or more portions of one or more computer systems 1600. Herein, reference to a computer system can encompass a computing device, and vice versa, where appropriate. Moreover, reference to a computer system can encompass one or more computer systems, where appropriate.

This disclosure contemplates any suitable number of computer systems 1600. This disclosure contemplates computer system 1600 taking any suitable physical form. As example and not by way of limitation, computer system 1600 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1600 can include one or more computer systems 1600, be unitary or distributed, span multiple locations, span multiple machines, span multiple data centers, or reside in a cloud, which can include one or more cloud components in one or more networks. Where appropriate, one or more computer systems 1600 can perform without substantial spatial or temporal limitation one or more steps of one or more methods described or illustrated herein. As an example, and not by way of limitation, one or more computer systems 1600 can perform in real time or in batch mode one or more steps of one or more methods described or illustrated herein. One or more computer systems 1600 can perform at different times or at different locations one or more steps of one or more methods described or illustrated herein, where appropriate.

In exemplary embodiments, computer system 1600 includes a processor 1602, memory 1604, storage 1606, an input/output (I/O) interface 1608, a communication interface 1610, and a bus 1612. Although this disclosure describes and illustrates a particular computer system having a particular number of particular components in a particular arrangement, this disclosure contemplates any suitable computer system having any suitable number of any suitable components in any suitable arrangement.

In exemplary embodiments, processor 1602 includes hardware for executing instructions, such as those making up a computer program. As an example, and not by way of limitation, to execute instructions, processor 1602 can retrieve (or fetch) the instructions from an internal register, an internal cache, memory 1604, or storage 1606; decode and execute them; and then write one or more results to an internal register, an internal cache, memory 1604, or storage 1606. In particular embodiments, processor 1602 can include one or more internal caches for data, instructions, or addresses. This disclosure contemplates processor 1602 including any suitable number of any suitable internal caches, where appropriate. As an example, and not by way of limitation, processor 1602 can include one or more instruction caches, one or more data caches, and one or more translation lookaside buffers (TLBs). Instructions in the instruction caches can be copies of instructions in memory 1604 or storage 1606, and the instruction caches can speed up retrieval of those instructions by processor 1602. Data in the data caches can be copies of data in memory 1604 or storage 1606 for instructions executing at processor 1602 to operate on; the results of previous instructions executed at processor 1602 for access by subsequent instructions executing at processor 1602 or for writing to memory 1604 or storage 1606; or other suitable data. The data caches can speed up read or write operations by processor 1602. The TLBs can speed up virtual-address translation for processor 1602. In particular embodiments, processor 1602 can include one or more internal registers for data, instructions, or addresses. This disclosure contemplates processor 1602 including any suitable number of any suitable internal registers, where appropriate. Where appropriate, processor 1602 can include one or more arithmetic logic units (ALUs), be a multi-core processor, or include one or more processors 1602. Although this disclosure describes and illustrates a particular processor, this disclosure contemplates any suitable processor.

In exemplary embodiments, memory 1604 includes main memory for storing instructions for processor 1602 to execute or data for processor 1602 to operate on. As an example, and not by way of limitation, computer system 1600 can load instructions from storage 1606 or another source (such as, for example, another computer system 1600) to memory 1604. Processor 1602 can then load the instructions from memory 1604 to an internal register or internal cache. To execute the instructions, processor 1602 can retrieve the instructions from the internal register or internal cache and decode them. During or after execution of the instructions, processor 1602 can write one or more results (which can be intermediate or final results) to the internal register or internal cache. Processor 1602 can then write one or more of those results to memory 1604. In particular embodiments, processor 1602 executes only instructions in one or more internal registers or internal caches or in memory 1604 (as opposed to storage 1606 or elsewhere) and operates only on data in one or more internal registers or internal caches or in memory 1604 (as opposed to storage 1606 or elsewhere). One or more memory buses (which can each include an address bus and a data bus) can couple processor 1602 to memory 1604. Bus 1612 can include one or more memory buses, as described below. In exemplary embodiments, one or more memory management units (MMUs) reside between processor 1602 and memory 1604 and facilitate accesses to memory 1604 requested by processor 1602. In particular embodiments, memory 1604 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 1604 can include one or more memories 1604, where appropriate. Although this disclosure describes and illustrates particular memory, this disclosure contemplates any suitable memory.

In exemplary embodiments, storage 1606 includes mass storage for data or instructions. As an example, and not by way of limitation, storage 1606 can include a hard disk drive (HDD), a floppy disk drive, flash memory, an optical disc, a magneto-optical disc, magnetic tape, a Universal Serial Bus (USB) drive, or a combination of two or more of these. Storage 1606 can include removable or non-removable (or fixed) media, where appropriate. Storage 1606 can be internal or external to computer system 1600, where appropriate. In exemplary embodiments, storage 1606 is non-volatile, solid-state memory. In particular embodiments, storage 1606 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), flash memory, or a combination of two or more of these. This disclosure contemplates mass storage 1606 taking any suitable physical form. Storage 1606 can include one or more storage control units facilitating communication between processor 1602 and storage 1606, where appropriate. Where appropriate, storage 1606 can include one or more storages 1606. Although this disclosure describes and illustrates particular storage, this disclosure contemplates any suitable storage.

In exemplary embodiments, I/O interface 1608 includes hardware, software, or both, providing one or more interfaces for communication between computer system 1600 and one or more I/O devices. Computer system 1600 can include one or more of these I/O devices, where appropriate. One or more of these I/O devices can enable communication between a person and computer system 1600. As an example, and not by way of limitation, an I/O device can include a keyboard, keypad, microphone, monitor, mouse, printer, scanner, speaker, still camera, stylus, tablet, touch screen, trackball, video camera, another suitable I/O device, or a combination of two or more of these. An I/O device can include one or more sensors. This disclosure contemplates any suitable I/O devices and any suitable I/O interfaces 1608 for them. Where appropriate, I/O interface 1608 can include one or more device or software drivers enabling processor 1602 to drive one or more of these I/O devices. I/O interface 1608 can include one or more I/O interfaces 1608, where appropriate. Although this disclosure describes and illustrates a particular I/O interface, this disclosure contemplates any suitable I/O interface.

In exemplary embodiments, communication interface 1610 includes hardware, software, or both, providing one or more interfaces for communication (such as, for example, packet-based communication) between computer system 1600 and one or more other computer systems 1600 or one or more networks. As an example, and not by way of limitation, communication interface 1610 can include a network interface controller (NIC) or network adapter for communicating with an Ethernet or other wire-based network or a wireless NIC (WNIC) or wireless adapter for communicating with a wireless network, such as a Wi-Fi network. This disclosure contemplates any suitable network and any suitable communication interface 1610 for it. As an example, and not by way of limitation, computer system 1600 can communicate with an ad hoc network, a personal area network (PAN), a local area network (LAN), a wide area network (WAN), a metropolitan area network (MAN), one or more portions of the Internet, or a combination of two or more of these. One or more portions of one or more of these networks can be wired or wireless. As an example, computer system 1600 can communicate with a wireless PAN (WPAN) (such as, for example, a BLUETOOTH WPAN), a Wi-Fi network, a WI-MAX network, a cellular telephone network (such as, for example, a Global System for Mobile Communications (GSM) network), other suitable wireless network, or a combination of two or more of these. Computer system 1600 can include any suitable communication interface 1610 for any of these networks, where appropriate. Communication interface 1610 can include one or more communication interfaces 1610, where appropriate. Although this disclosure describes and illustrates a particular communication interface, this disclosure contemplates any suitable communication interface.

In particular embodiments, bus 1612 includes hardware, software, or both, coupling components of computer system 1600 to each other. As an example and not by way of limitation, bus 1612 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1612 can include one or more buses 1612, where appropriate. Although this disclosure describes and illustrates a particular bus, this disclosure contemplates any suitable bus or interconnect.

Herein, a non-transitory, computer-readable storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable non-transitory, computer-readable storage media, computer readable medium, or any suitable combination of two or more of these, where appropriate. A non-transitory, computer-readable storage medium can be volatile, non-volatile, or a combination of volatile and non-volatile, where appropriate.

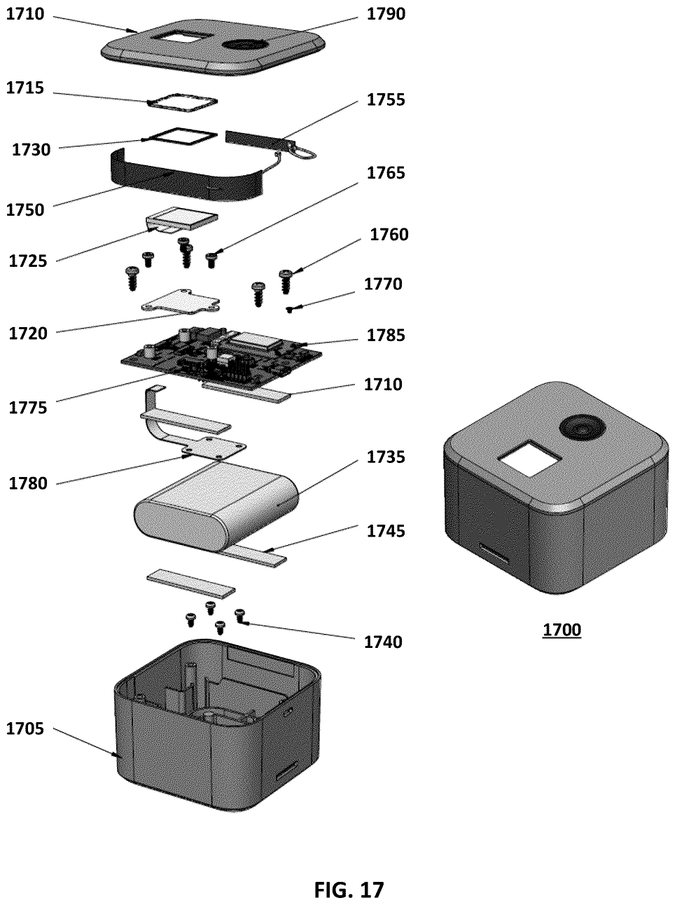

FIGS. 17A and 17B illustrate another example of a smart sensor device 1700 having a user display 1725, a multi-function button 1790, and incorporating Pulsed Coherent Radar (PCR) sensing technology to monitor container contents. In additional examples, ultrasonic sensing technology can also be used. FIG. 17A illustrates an exploded view of the example smart sensor device 1700 and its associated components.

The body 1705 can be a hollow container capable of holding various physical and electronic components. Top cap 1710 may cover, contain, and seal those components inside the hollow area of the body 1705. In examples, the body 1705 and top cap 1710 may be a square or rectangular shape. In other examples, the shape may be rounded, spherical, or cylindrical, as seen in FIGS. 1A-1B.

The display 1725 can be a liquid crystal display, for example. A window 1715 may be provided on the top cap 1710. A display support 1740 can support a bottom portion of the display 1725 and related components so that it is stable in the proper position. A display gasket 1730 can also be provided to surround a rim of the display. In some examples, the display gasket 1730 maintain a seal to prevent liquid, dirt, debris, and other particles from entering an interior area of the container.

A battery pack 1735 can be provided inside the container. In some examples, the battery pack 1735 is positioned beneath sensor 1780. The sensor 1780 may be a radar sensor, such as a PCR sensor. In additional examples, one or more additional sensors could be included, such as an accelerometer, gyroscope, or other.

The PCR sensing capability may provide 60 GHz pulses and enable the smart sensor to be placed anywhere on top of the desired container while still providing precise measurements of the material inside. In examples, the high-frequency PCR pulses can penetrate through various plastic materials, enabling the device to accurately detect liquid levels, material densities, and other relevant parameters without direct contact with the container contents.

The 60 GHz PCR sensing capability further provides flexibility in mounting options, and can be applicable to plastic containers, metal drums, and other types of containers, made of one or more materials. In examples, the smart sensor can be placed on any suitable location on the container, such as the lid or an exterior surface, thus eliminating the need for specific attachment points or modifications to existing containers. This feature is particularly beneficial in scenarios where containers may have irregular shapes or when rapid deployment across multiple containers is required.

One or more sets of screws can be provided to stabilize and secure components within the smart sensor device. A first thread-forming screw set 1740 may be provided on a base portion of the smart sensor device 1700. The screw set 1740 may hold a base plate and other components within the device. In examples, the screw set 1740 is a set of 4 screws, such as a 3×5 mm thread-forming screws. A second screw set 1760 can hold one or more components on the logic board and can secure the logic board in position. The second screw set may be 4×100 mm thread-forming screws. A third screw set 1765 may hold the display support 1720 in place. In examples, the third screw set 1765 secures one or more components to the logic board. The third screw set can include 3×5 mm thread-forming screws. One or more mounting screws 1770 can be provided to secure different components, such as components to attach to the logic board 1775.

In additional examples, an adhesive 1745, such as double-sided tape, can secure various stacked components within the smart sensor device 1700. For example, the logic board 1775 can be held in a desired position, e.g., against the battery back, adjacent to a sensor, radio, etc., using the adhesive 1745. In examples, the adhesive 1745 may also be positioned on a bottom portion of body 1705 to help secure the body to a container. In some examples, the body 1705 may have a recess or other specified area for adhesive 1745. Multiple adhesives may be provided on different areas of the body.

The smart sensor device 1700 can also include one or more antennas, such as an LTE (Long Term Evolution) antenna 1750 and a BLE (Bluetooth Low Energy) antenna 1755. Additional types of antennas and communication features can be included.

A logic board 1775 can provide the PCR sensing capability, in conjunction with sensor 1780 (e.g., a radar sensor, a radar sensor with a radar lens, etc.), radio 1785, and antennas 1750, 1755. The radio 1785 which can communication data obtained by the smart sensor to one or more computing devices. In some embodiments, the smart sensor may include multiple PCR sensors to provide a more comprehensive view of the container contents. This could be particularly applicable for monitoring non-homogeneous materials or detecting irregularities in material distribution within the container. Additionally, advanced signal processing algorithms may be employed to filter out potential interference and improve measurement accuracy in challenging environments.

Additionally, while the PCR sensing may be functional through container lids and through various materials, the smart sensor can also be attached to an opening, such as a container bunghole, as discussed herein. In some examples, a direct line of sight into the container may be preferred, required, and/or beneficial. For example, some container materials, such as steel, may interfere with the PCR sensing. Therefore, to accommodate any placement preferences and ensure accuracy, the smart sensor device can be equipped with an alternative attachment mechanism, such as clip-on threads, to allow for secure and easy attachment to standard bunghole openings on steel drums and containers.

In examples, an attachment, such as a clip-on thread system, can be included to enable the smart sensor to be compatible with various container standards and container types, thereby ensuring that the smart sensor can be quickly and securely fastened to various container and material types. This modular approach allows users to easily switch the smart sensor between containers and container types (e.g., plastic and steel containers, various sized containers, etc.) as needed.

In additional examples, the sensor 1780 can include an Inertial Measurement Unit (IMU) incorporated into the smart sensor device. The IMU can include one or more accelerometers and gyroscopes, to enable the device to detect and measure various types of motion, including linear acceleration, angular velocity, and orientation changes.

With an IMU, the smart sensor can sense and monitor shock and vibration experienced by the container. This capability can be crucial for detecting potential mishandling during transportation, storage, or general use. In various examples, the device can record sudden impacts, excessive shaking, and abnormal movements that may indicate rough handling or accidents. Such information can be invaluable for quality control, logistics management, and ensuring the integrity of sensitive materials.

In some examples, the IMU data can be used to generate detailed motion profiles for a container over a period of time. Such profiles can provide insights into the container's status and use, from its initial filling onwards. By analyzing this data, users can identify patterns of use or mishandling and implement better handling procedures to minimize the risk of damage to container contents.

In some examples, the smart sensor may use the IMU data in conjunction with other sensors to provide more comprehensive monitoring. For example, sudden changes in orientation detected by the IMU could trigger additional measurements from the PCR sensor to check for potential spills or leaks. This multi-sensor approach can enhance the overall reliability and effectiveness of the monitoring system.

Additional examples of the smart sensor may incorporate machine learning algorithms to analyze IMU data and identify specific types of events or handling patterns. Over time, the device could learn to distinguish between normal transportation vibrations and potentially damaging impacts, providing more accurate and relevant alerts to users.

As discussed above, the smart sensor device may utilize GPS and provide location-tracking capabilities. Additional examples may be expanded to further leverage cellular network information, to complement its existing GPS functionality. As such, cellular coverage may may enhance the device's ability to provide accurate positioning data across a wide range of environments and scenarios.

Further, by utilizing cellular network information, the smart sensor can determine its approximate location even in areas where GPS signals may be weak or unavailable. This is particularly useful in urban environments with tall buildings, indoor storage facilities, or underground locations where traditional GPS tracking might be unreliable, among others. The device can triangulate its position based on the strength and timing of signals from nearby cell towers, providing a reasonably accurate location estimate.

The integration of cellular-based location tracking can also enable more efficient power management. Since many GPS receivers consume more power than cellular modules, the smart sensor may be able to switch between GPS and cellular location methods based on signal availability and battery status. Such adaptive approaches can help extend the device's operational life while maintaining consistent location tracking capabilities.

In some implementations, the smart sensor may employ a hybrid location system that combines data from GPS, cellular networks, and other available sources, such as Wi-Fi access points. This multi-source approach can provide more robust and precise location information, especially in challenging environments where a single method might be insufficient.

Various embodiments may also integrate other positioning technologies, such as ultra-wideband (UWB) for high-precision indoor tracking or the use of low-power wide-area network (LPWAN) technologies for extended range in remote areas. These advancements could further improve the smart sensor's ability to provide accurate and reliable location data across an even broader range of operational scenarios.

As discussed above, a display 1725 may be incorporated with the smart sensor. The display may be a Thin Film Transistor (TFT) Liquid Crystal Display (LCD), for example, or other types. The display can provide a clear, easily readable interface for users to quickly access important information about the container contents and the device's status. The display can further include a backlight to enhance readability, and allow, for example, the display to be used effectively in low-light environments, such as dimly lit warehouses or during nighttime operations.

In various examples, the display can provide a range of critical information, including but not limited to current sensor readings from the PCR sensor and IMU. Users can, for example, quickly check liquid levels, material densities, or other relevant parameters directly on the smart sensor itself. This immediate access to data can greatly improve operational efficiency, allowing workers to make quick decisions without the need to consult external monitoring systems.

In addition to raw sensor data, the display can present analytics derived from the collected information. This may include trends in material usage, predictions for refill timing, or alerts about unusual changes in container contents. The display can also provide information regarding the device's health and status. Users can easily check battery levels, network connectivity strength, and other system parameters. Such features can assist with monitoring and ensuring that the smart sensor is functioning correctly.

In some implementations, the display may offer customizable views, allowing users to configure which information is shown based on their specific needs or preferences. This flexibility can make the smart sensor more versatile across different industries and use cases, from chemical storage to food and beverage management.

As noted above, FIG. 17A and 17B illustrate a multi-function button 1790 (also referred to herein as a user button) on the smart sensor device to provide an interface for interacting with the device. This button may be multi-functional and serve as the primary means for users to control the smart sensor's display and initiate various actions.

The multi-function button 1790 can also be designed to activate the display. In examples, to conserve battery life, the display may be configured to remain off when not in use. A button press may wake up the display, which can then provide container and/or analytics information to the user.

In some examples, the user button can be used to initiate a measurement on demand. While the smart sensor may be configured to take regular automated measurements, there may be situations where a user desires or needs to check the current status of the container contents immediately. A specific button press sequence, such as a single-click, double-click, or a long press, for example, could trigger the device to take a new set of measurements using its various sensors and update the display with the latest data.

Another function of the user button is to allow users to page through different information screens on the display. Given the limited size of the display and the potentially large amount of data and analytics available, the ability to cycle through multiple screens of information is necessary. Users can press the button, or in some examples, perform a particular button sequence, to navigate through various data views, such as current sensor readings, historical trends, device status, and any alerts or notifications, among others.

In some implementations, the user button may also support more advanced interactions through different types of presses or sequences. For example, a series of short presses might navigate forward through menu options, while a long press could select an option or return to the main screen. This approach allows for a relatively complex user interface to be controlled through a single button, maximizing functionality while maintaining simplicity.

The smart sensor device may be integrated with various third-party data inputs to enhance its monitoring and analysis capabilities. In some aspects, the device may interface with external hardware controllers to allow for remote operation or automation of container-related processes. Sensing devices may also be integrated as third-party inputs to provide additional data, such as environmental data. This could include external temperature sensors, humidity monitors, or pressure gauges that complement the smart sensor's internal sensors. By incorporating data from these external sensors, the smart sensor may provide a more comprehensive view of the container's conditions and contents.

Internet data sources may also be leveraged to enhance the smart sensor's functionality and analytical capabilities. For instance, the device could access weather forecasts to predict how temperature changes might affect the container contents. Market pricing data for the stored materials could be integrated to provide real-time valuation of inventory. Shipping and logistics information could be incorporated to optimize supply chain management based on current container levels.

The smart sensor may also be designed to output data to various third-party systems. Integration with Enterprise Resource Planning (ERP) systems could allow for automatic inventory updates and procurement triggers based on container levels. Customer Relationship Management (CRM) systems could receive alerts when customer-specific inventory thresholds are reached, enabling proactive communication and order fulfillment. Building Management Systems (BMS) may interface with the smart sensor to incorporate container data into overall facility monitoring and control.

In some implementations, the smart sensor may act as a data hub, collecting information from its own sensors and third-party inputs, then distributing relevant data to various output systems. This could involve preprocessing or aggregating data to meet the specific needs of each connected system.

To facilitate these integrations, the smart sensor may incorporate standard communication protocols to allow for easy connection to a wide range of existing industrial and commercial systems. In some cases, custom integration modules could be developed to bridge any compatibility gaps between the smart sensor and specific third-party systems.

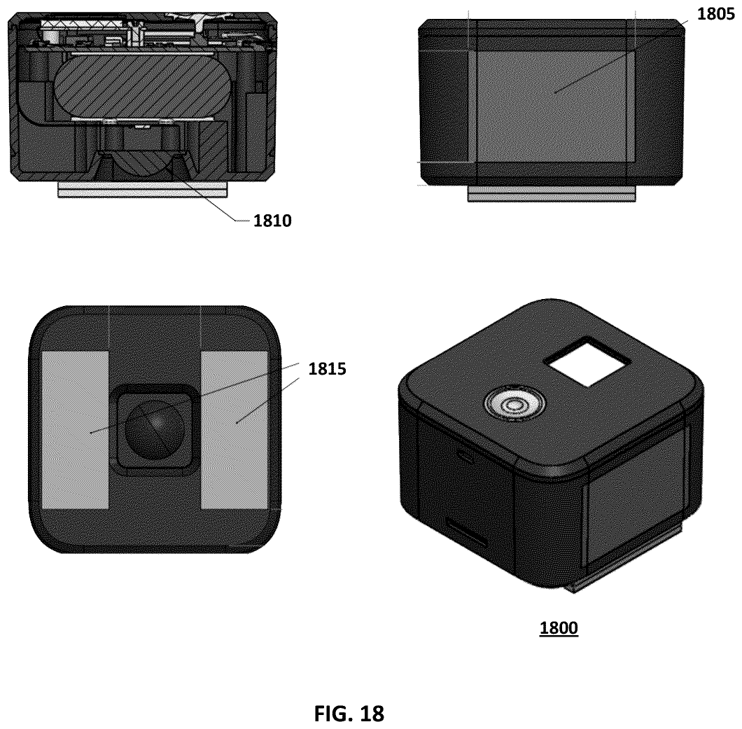

FIG. 18 illustrates various views of an additional smart sensor design 1800. Features associated smart sensor 1800 and other examples discussed herein can be interchanged between devices, depending on size and design considerations. From the top left going clockwise, FIG. 18 illustrates a cross-sectional view of smart sensor 1800; a side view of smart sensor 1800; an outer, perspective view of smart sensor 1800; and a bottom view of smart sensor 1800. As discussed herein, the smart sensor 1800 can include the components and features discussed in FIG. 17, including but not limited to a battery pack, one or more sensors, a user button, secure body, one or more screws, supports, and display screens. A side panel 1805 of the smart sensor 1800 can be a material for labeling, such as a metal for engraving. Such panel can enable design variations or provide technical details or other information about the device. In some examples, an attachment 1800 can secure the body of the smart sensor to one or more internal components. In examples, the attachment 1800 can be formed via an ultrasonic weld. One or more adhesives 1815 can be provided on an outer, bottom side of the smart sensor 1800 to help secure the device to a container, such as a lid to a container, as discussed herein. In examples, the adhesive 1815 can be a same or similar product as adhesive 1745.

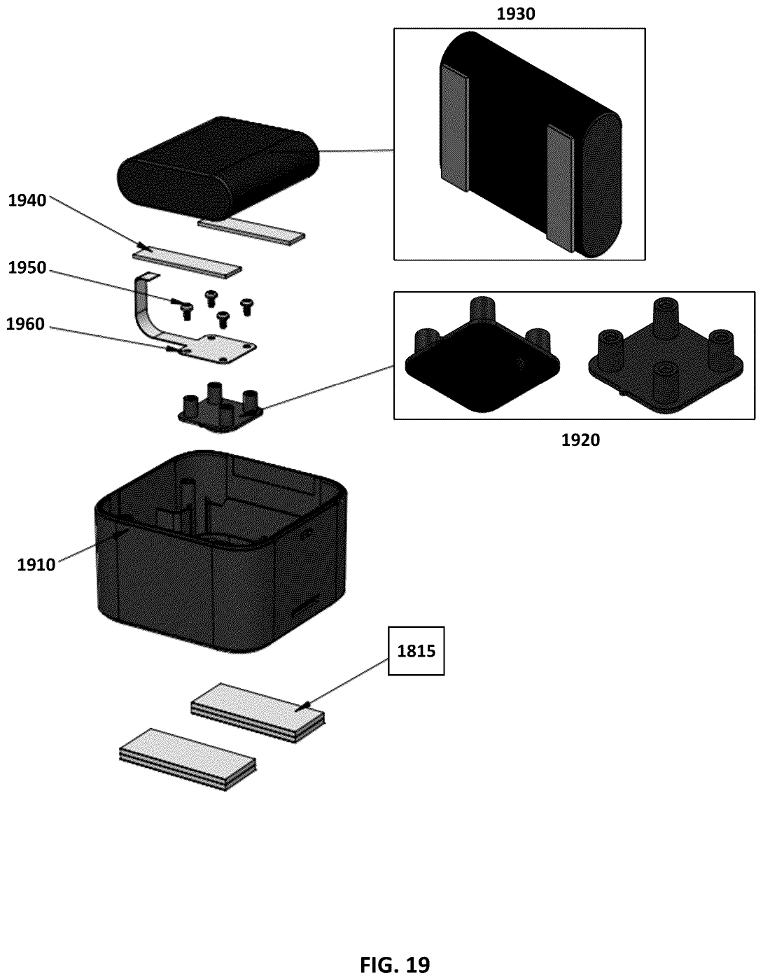

FIG. 19 illustrates additional components of smart sensor 1800. Battery pack assembly 1930 can include a lithium-ion battery pack. One or more adhesives 1940, which may be the same or similar to adhesives 1745 and 1815 can be provided on the battery pack assembly 1930, such as a bottom side, in order to secure the battery pack assembly within the body 1910 of smart sensor 1800. A radar lens 1920 can also be provided within the body 1910 of smart sensor 1800. In examples, the radar lens 1920 can be provided on a bottom portion of the body and sit in a recessed area to hold the radar lens in place. The radar lens 1920 may be visible from the bottom, outer side of the body 1910, as seen in FIG. 18 (circular portion between adhesives 1815). The radar lens 1920 can focus radar signals into a narrow beam, to improve range and accuracy of the beams, and assist in the transmission of electromagnetic waves for target detection, as discussed herein. The radar lens 1920 can include an assembly with multiple prongs (e.g., four prongs) that extend from a top plate and upon which a radar sensor 1960 may sit and be secured to via a set of attachments 1950 (e.g., screws). It should be appreciated that additional components from FIG. 17 can also be incorporated into the depicted design, including but not limited to the logic board, top cap, LCD window, antennas (LTE, BLE, etc.), and the like.

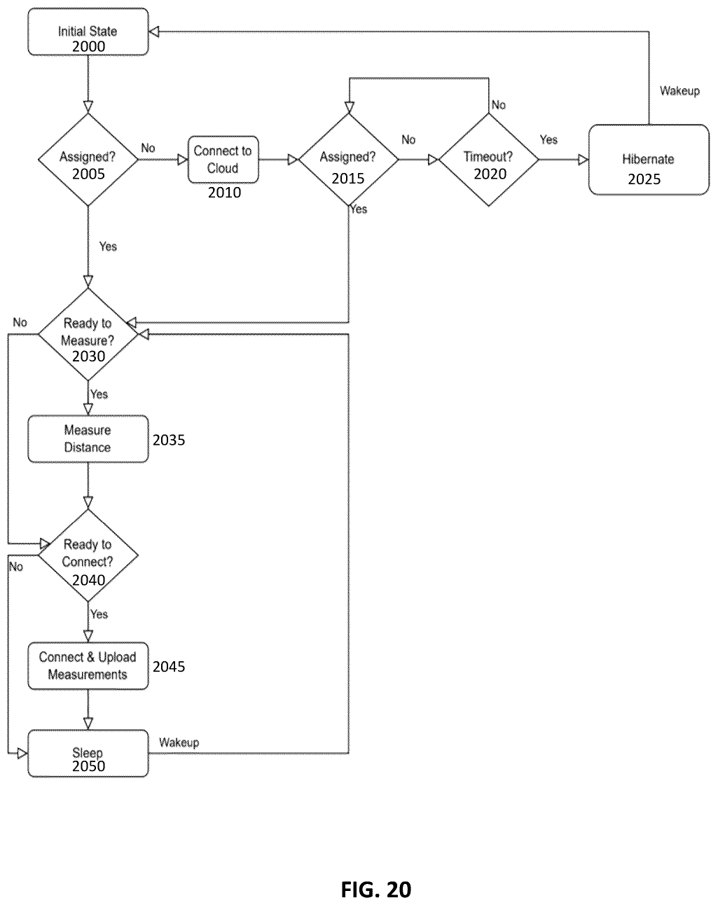

FIG. 20 illustrates an example firmware flow. The flow may be associated with an application operating via one or more processors on a user device, such as a computing device, and demonstrates the operational flow of any of the smart sensor device examples discussed herein. At an initial state 2000, which may occur after a wakeup notification or user initiation, the system may determine an assignment status 2005. If the smart sensor device is assigned, then a ready to measure determination 2030 is conducted. If the smart sensor device is determined not to be assigned, an attempt is made to connect to the cloud 2010, and again determine an assignment 2015. If no assignment is determined, the device determines whether to timeout 2020. In examples, a timeout can cause the device to hibernate 2025 for a period of time. When the device receives a wakeup notification, it resumes its initial state 2000. In other examples, if a timeout is not initiated, an assignment determination 2015 is determined again. If the device is determined to be assigned, the ready to measure determination 2030 is initiated.

If the device is not ready to measure, then a ready to connect determination 2040 occurs. If the device is ready to measure, it initiates a measure distance 2035 operation and then the ready to connect determination 2040. If the device has a negative ready to connect determination, the device goes to sleep 2050 until it wakes up and again initiates the ready to measure determination 2030. If the device is ready to connect, the device connects and uploads measurements 2045. The measurement can be sent, for example, to an external device, such as a computing device, phone, or other device that can connect to the smart sensor device. After connect and upload measurements 2045 occurs, the device goes to sleep 2050 until it wakes up and initiates the ready to measure determination 2030.

In an embodiment, a smart cap device, comprises: a base portion attached to an opening of a container containing a material; and an internal cavity housing a sensor to detect a level of the material within the container; and a processor and at least one memory configured to generate an alert based on the level of the material.

In an embodiment, wherein the sensor detects the level of the material using laser time of flight.

In an embodiment, wherein the sensor comprises at least one of a laser sensor, a distance sensor, a photosensor, a pH sensor, and a temperature sensor.

In an embodiment, wherein the level of the material within the container is associated with a first time, and wherein the processor and at least one memory are further configured to: determine a usage trend based on the level of the material measured at a first time and the level of material measured at the sensor at a second time; and generate a second alert based on the usage trend.

In an embodiment, wherein the alert comprises at least one of: illuminating a light source and generating a notification on a remote computing device.

In an embodiment, wherein the sensor system detects, via a first sensor, a first level of a material within the container system at a first time; and provides information indicative of the first level of the material to a remote computing device.

In an embodiment, wherein the base portion seals the opening of the container.

In an embodiment, wherein the container is a 55-gallon drum.

In an embodiment, further comprising a removable lid providing access to the internal cavity, wherein the internal cavity further houses a battery to power the sensor system.

In an embodiment, further comprising charging port to receive power for the sensor system.

In an embodiment, wherein the material is a liquid.

In an embodiment, a method for monitoring a container system, comprises: detecting, via a first sensor, a first level of a material within the container system at a first time, wherein the first sensor is provided within a smart cap device attached to an opening of the container system; and providing information indicative of the first level of the material to a remote computing device.

In an embodiment, further comprising: detecting, via the first sensor, a second level of the material at a second time; determining a usage trend for the material based on the first level and the second level; and providing a notification comprising the usage trend to the remote computing device.

In an embodiment, wherein the usage trend is at least one of: a rate of depletion, a current level of the material, or an estimated depletion time.

In an embodiment, further comprising: detecting, via a second sensor, at least one of: temperature, pressure, pH, or light.

In an embodiment, further comprising: determining a safety hazard based on the second sensor; and providing a notification indicative of the safety hazard to the remote computing device.

In an embodiment, further comprising sealing the opening of the container system via a base portion of the smart cap device.

In an embodiment, a non-transitory, computer-readable medium comprises instructions stored thereon which, when executed by a processor, cause a computing device to: determine a usage trend regarding a quantity of material within a container system, using at least one sensor provided within a smart cap device attached to an opening of the container system; and generate an alert based on the usage trend.

In an embodiment, wherein the alert is provided on a remote computing device.

In an embodiment, wherein the usage trend is at least one of: a rate of depletion, a current level of the material, or an estimated depletion time.

In an embodiment, a smart sensor device can comprise: a base portion attached to an exterior of a container having known dimensions containing a material; an internal cavity housing a sensor to detect a level of the material within the container, wherein sensor detects the level of the material through an outer surface of the container; and a processor, and at least one memory configured to generate an alert based on the level of the material.

In an embodiment, wherein the sensor detects the level of the material using pulsed coherent radar.

In an embodiment, further comprising an inertial measurement unit to detect at least one of a shock, a vibration, and a movement experienced by the container.

In an embodiment, further comprising a display providing at least one of: current sensor readings, analytics derived from the detected level of material, and device information.

In an embodiment, further comprising a multi-function button to perform operational actions comprising at least one of: initiating the sensor to detect the level of the material and operating the display.

In an embodiment, wherein the display comprises at least one of a liquid crystal display and a backlight.

In an embodiment, further comprising at least one of a laser sensor, a distance sensor, a photosensor, a pH sensor, a temperature sensor, a location sensor, and a cellular connection.

In an embodiment, a method for monitoring a container system, comprises: detecting, via a first sensor, a first level of a material within the container system at a first time, wherein the first sensor is provided within a smart sensor device attached to an exterior of the container system, and wherein first sensor detects the level of the material through an outer surface of the container; and providing information indicative of the first level of the material to a remote computing device.

In an embodiment, further comprising activating, via a multi-function on the smart sensor device, at least one of: a display associated with the smart sensor device, and the sensor to detect the level of the material.

In an embodiment, wherein the display provides at least one of: a current sensor reading, analytics derived from the detected level of material, and information about the smart sensor device.

In an embodiment, a non-transitory, computer-readable medium comprising instructions stored thereon which, when executed by a processor, cause a computing device to: determine a usage trend regarding a quantity of material within a container system, using at least one sensor provided within a smart sensor device attached to an exterior of the container system, wherein the at least one sensor detects the level of the material through an outer surface of the container; and generate an alert based on the usage trend.

In an embodiment, further comprising instructions to activate a display associated with the smart sensor device to provide at least one of: a current sensor reading, analytics derived from the detected level of material, and information about the smart sensor device.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments can include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments can provide none, some, or all of these advantages.

What is claimed:

1. A smart sensor device, comprising:
a base portion attached to an exterior of a container having known dimensions containing a material; an internal cavity housing a sensor to detect a level of the material within the container, wherein sensor detects the level of the material through an outer surface of the container; and a processor, and at least one memory configured to generate an alert based on the level of the material.

2. The smart sensor device of claim 1, wherein the sensor detects the level of the material using pulsed coherent radar.

3. The smart sensor device of claim 1, further comprising an inertial measurement unit to detect at least one of a shock, a vibration, and a movement experienced by the container.

4. The smart sensor device of claim 1, further comprising a display providing at least one of: current sensor readings, analytics derived from the detected level of material, and device information.

5. The smart sensor device of claim 4, further comprising a multi-function button to perform operational actions comprising at least one of: initiating the sensor to detect the level of the material, and operating the display.

6. The smart sensor device of claim 4, wherein the display comprises at least one of a liquid crystal display and a backlight.

7. The smart sensor device of claim 1, further comprising at least one of a laser sensor, a distance sensor, a photosensor, a pH sensor, a temperature sensor, a location sensor, and a cellular connection.

8. The smart sensor device of claim 1, wherein the level of the material within the container is associated with a first time, and wherein the processor and at least one memory are further configured to:
determine a usage trend based on the level of the material measured at a first time and the level of material measured at the sensor at a second time; and
generate a second alert based on the usage trend.

9. The smart sensor device of claim 1, wherein the sensor system detects, via a first sensor, a first level of a material within the container system at a first time; and provides information indicative of the first level of the material to a remote computing device.

10. The smart sensor device of claim 1, further comprising a removable lid providing access to the internal cavity, wherein the internal cavity further houses a battery to power the sensor system.

11. A method for monitoring a container system, comprising:
detecting, via a first sensor, a first level of a material within the container system at a first time, wherein the first sensor is provided within a smart sensor device attached to an exterior of the container system, and wherein first sensor detects the level of the material through an outer surface of the container; and
providing information indicative of the first level of the material to a remote computing device

12. The method of claim 11, further comprising:
detecting, via the first sensor, a second level of the material at a second time;
determining a usage trend for the material based on the first level and the second level; and
providing a notification comprising the usage trend to the remote computing device.

13. The method of claim 12, wherein the usage trend is at least one of: a rate of depletion, a current level of the material, or an estimated depletion time.

14. The method of claim 11, further comprising: determining a safety hazard based on the second sensor; and providing a notification indicative of the safety hazard to the remote computing device.

15. The method of claim 11, further comprising activating, via a multi-function on the smart sensor device, at least one of: a display associated with the smart sensor device and the sensor to detect the level of the material.

16. The method of claim 15, wherein the display provides at least one of: a current sensor reading, analytics derived from the detected level of material, and information about the smart sensor device.

17. A non-transitory, computer-readable medium comprising instructions stored thereon which, when executed by a processor, cause a computing device to:
determine a usage trend regarding a quantity of material within a container system, using at least one sensor provided within a smart sensor device attached to an exterior of the container system, wherein the at least one sensor detects the level of the material through an outer surface of the container; and
generate an alert based on the usage trend.

18. The non-transitory, computer-readable medium of claim 17, further comprising instructions to activate a display associated with the smart sensor device to provide at least one of: a current sensor reading, analytics derived from the detected level of material, and information about the smart sensor device.

19. The non-transitory, computer-readable medium of claim 17, wherein the alert is provided on a remote computing device.

20. The non-transitory, computer-readable medium of claim 17, wherein the usage trend is at least one of: a rate of depletion, a current level of the material, or an estimated depletion time.
